(19) United States
(12) Patent Application Publication
(10) Pub. No.: US 2010/0184481 A1
(43) Pub. Date: Jul. 22, 2010

(54) Controlling Advertising on Displays

(76) Inventor: Shimon Alfasi, Kiryat Haim (IL)

Correspondence Address: The Law Office of Michael E. Kondoudis, 888 16th Street, N.W., Suite 800, Washington, DC, 20006, US

(21) Appl. No.: 12/357,522

(22) Filed: Jan. 22, 2009

(51) Int. Cl. H04B 1/38; G06Q 30/00

(52) U.S. Cl. 455/566; 705/14.4

(57) ABSTRACT

A data processing system for controlling a display. The system comprises a control unit connected to the display and a communication device connected via a communication link to the control unit. The control unit comprises a communication unit and a converter. The communication device is arranged to send messages via the communication link to the communication unit of the control unit. The converter is arranged to convert the messages to instructions relating to content items. The display is arranged to display the content items according to the instructions from the control unit. The content items contain advertisements and the messages controlling the display of the content may be sent per SMS messages. Content may be sent per MMS messages. The communication device may comprise a cellular phone and the communication unit may comprise a SIM card.

### BACKGROUND

1. Technical Field

The present invention relates to the field of advertising systems, and more particularly, to remotely controlled display system.

2. Discussion of Related Art

Advertising on displays is very common, yet controlling the presented content requires large resources and personnel, while the displays themselves may be distributed over a large area.

The following patents and patent applications are incorporated herein by reference in their entirety: WIPO Publication No. WO08037285A1, which discloses a method of transferring broadcast related information from a portable terminal to a nearby broadcast receiver. European Patent Document No. EP1657941A1, which discloses a method for controlling a sub-device of mobile equipment using a SIM application toolkit. U.S. Patent Publication No. US20080021777, which discloses a system for displaying visual content. WIPO Publication No. WO02086852, which discloses a system for displaying information, such as advertising, at a remote site. WIPO Publication No. WO0229665, which discloses a system for interactive information display on a billboard. U.S. Patent Publication No. US2008140481, which discloses a system utilizing a presentation content production pipeline, where during the event presentation operation a set of rules for the determination of aspects of the available managed advertising is established. U.S. Patent Publication No. US2007168414, which discloses a system for managing advertising devices. U.S. Patent Publication No. US2005021393, which discloses a smart interactive billboard device. WIPO Publication No. WO08037285, which discloses a method of transferring broadcast related information from a portable terminal to a nearby broadcast receiver. European Patent Document No. EP1657941, which discloses a method for controlling a sub-device of mobile equipment using a SIM application toolkit.

### BRIEF SUMMARY

Embodiments of the present invention provide a data processing system for controlling a display. The data processing system comprises a control unit connected to the display and a communication device connected via a communication link to the control unit. The control unit comprises a communication unit and a converter. The communication device is arranged to send at least one message via the communication link to the communication unit of the control unit. The converter is arranged to convert the message to at least one instruction relating to at least one content item. The display is arranged to display the at least one content item according to the at least one instruction from the control unit.

Accordingly, according to an aspect of the present invention, the communication unit comprises a SIM card.

Accordingly, according to another aspect of the present invention, the at least one instruction comprises at least one of: timing of displaying at least one content item, display sizes of various content items, movements of the at least one content item, animation, colors and color changes in the at least one content item, audio characteristics of the at least one content item.

Embodiments of the present invention provide an advertising system comprising a plurality of displays and a plurality of control units, such that each of the displays is connected to a control unit comprising a communication unit and a converter; at least one communication device connected via at least one communication link to at least some of the control units; and a managing unit connected via at least one communication link to the plurality of control units and to the at least one communication device. The at least one communication device is arranged to send a plurality of messages via the at least one communication link to the communication units of the plurality of control units, such that each message is sent to at least one target control unit. In each control unit, the converter is arranged to convert each message sent to the control unit to at least one instruction relating to at least one content item. The plurality of displays are arranged to display content items according to the at least one instruction from the connected control unit. The managing unit is arranged to coordinate the plurality of displays in respect to the plurality of messages.

Accordingly, according to an aspect of the present invention, there is provided an advertising system further comprising at least one camera connected via the communication link to at least one communication device and arranged to collect viewer data relating to persons in front of the display. The managing unit is arranged to coordinate the plurality of displays in respect to the plurality of messages and in respect to the viewer data.

Accordingly, according to another aspect of the present invention, there is provided an advertising system further comprising external information sources. The managing unit is arranged to coordinate the plurality of displays in respect to the plurality of messages and in respect to data from the external information sources.

Embodiments of the present invention provide a method of controlling a display connected to a control unit. The method comprises the stages: sending a message via a communication link to the control unit; converting the message to at least one instruction relating to at least one content item; and displaying the at least one content item according to the at least one instruction.

Accordingly, according to an aspect of the present invention, the message is an SMS message and the method further comprises allowing a user to code the at least one instruction into the SMS message.

Accordingly, according to another aspect of the present invention, the message is an MMS message and the method further comprises allowing a user to add at least one content item into the MMS message.

Accordingly, according to yet another aspect of the present invention, there is provided a method further comprising using content templates to generate content in relation to the at least one instruction.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a high level schematic block diagram of a data processing system for controlling a display, according to some embodiments of the invention; and

FIG. 2 is a high level flowchart illustrating a method of controlling a display connected to a control unit, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

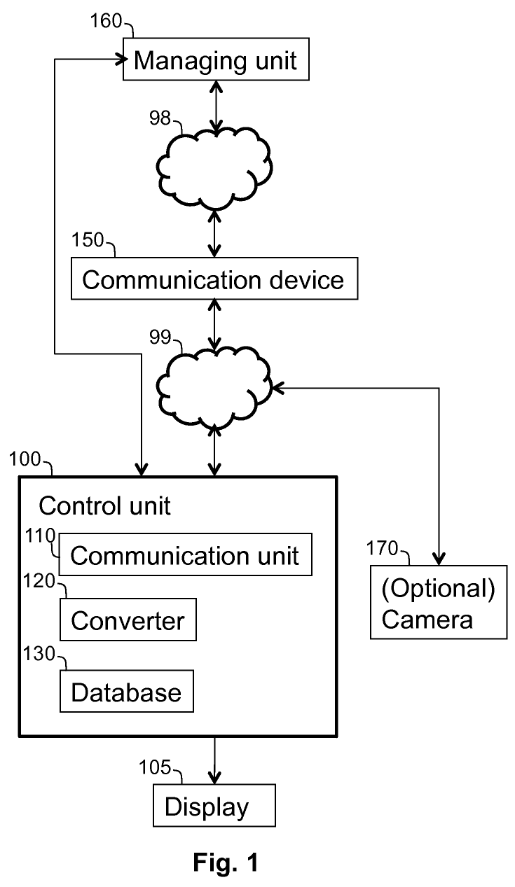

FIG. 1 is a high level schematic block diagram of a data processing system for controlling a display 105, according to some embodiments of the invention. The data processing system comprises a control unit 100 connected to display 105 an comprising a communication unit 110 and a converter 120. The data processing system further comprises a communication device 150 connected via a communication link 99 to control unit 100. Communication device 150 is arranged to send at least one message via communication link 99 to communication unit 110 of control unit 100.

According to some embodiments of the invention, display 105 may comprise any type of screen, such as a plasma display, an LCD display, a television, a projection screen as well as displays with associated processing units such as computers, cellular devices, personal digital assistants and the like.

According to some embodiments of the invention, control unit 100 may comprise a processing unit, a memory and input and output devices. According to some embodiments of the invention, control unit 100 may be integrated within display 105, for example within a computer, a media center, a web TV, etc.

Communication device 150 may comprise for example a cellular phone, and the message may comprise an SMS or an MMS. The message may comprise instructions for displaying advertisements, commercials and so forth, and may be coded in the message according to predefined rules, relating to predefined templates, and may include content to be integrated in the advertisement.

Communication unit 110 may comprise a SIM (Subscriber Identity Module) card for identifying allowed users and corresponding display 105.

Converter 120 is arranged to convert the message to at least one instruction relating to at least one content item. Display 105 is arranged to display the content items according to the instructions from control unit 100. Such instructions may comprise the timing (start, end, duration, cycles, etc.) for displaying the content items, display sizes of various content items, movements of content items (for example headers or objects), animation, colors and color changes in content items, audio characteristics of the content items and so forth. The content items themselves may be parts of advertisements or commercials, comprise data that may be selected as relevant for people in front of display 105, comprise content from various sources, including personally adapted content.

According to some embodiments of the invention, one communication device 150 may be associated with one or more control units 100 and displays 105, and each control unit 100 may be associated with one or more communication devices 150. A managing unit 160 may be connected to communication devices 150 via a communication link 98 (that may be the same or different from communication link 99) or to control units 100 and may be arranged to coordinate displays 105 in respect to the messages. For example, managing unit 160 may temporally and spatially coordinate an advertisement along several displays 105. Managing unit 160 may further comprise external information sources that may be incorporated to affect the displayed content—for example information relating to events in the proximity of certain displays 105 that may be allocated specific advertising.

According to some embodiments of the invention, managing unit 160 may be part of an advertising system, which further comprises a plurality of displays 105 and a plurality of control units 100, such that each display 105 is connected to a control unit 100, at least one communication device 150 connected via at least one communication link 99 to at least some of control units 100. Communication device 150 may send messages via communication link 99 to control units 100, which via converters 120 are converted to instructions relating to content items. Some of the messages may comprise content items. Each display 105 is arranged to display content items according to the instructions from the connected control unit 100, as coordinated by managing unit 160. Managing unit 160 may receive identification data from communication units 110 and communication devices 150 and may further handle databases 130 in control units 100. According to some embodiments of the invention, displays 105 may be associated with a shop, and content may be presented, that advertises the articles sold in the shop, or in associated and neighboring shops. Area for displays 105 may be rented by the user from shops in order to run the advertising system.

According to some embodiments of the invention, control unit 100 may further comprise a database 130 comprising content such as advertisements, to which at least part of the instructions relates. Database 130 may further comprise content templates, to which converter 120 may relate when converting the messages to instructions. The content templates may comprise for example animation patterns, color schemes, audio settings and so forth.

According to some embodiments of the invention, the data processing system and/or advertising system may comprise one of more cameras 170 connected via communication link 99 to communication device 150. Camera 170 may be arranged to collect viewer data relating to persons in front of display 105. Viewer data may comprise measuring how long people stay before the advertisement, number of people observing display 105, operation control of display 105 itself, estimating a number of approaching people, estimating the speed of passing persons and so on. Viewer data may be related to by control unit 100 or by managing unit 160 when coordinating displays 105.

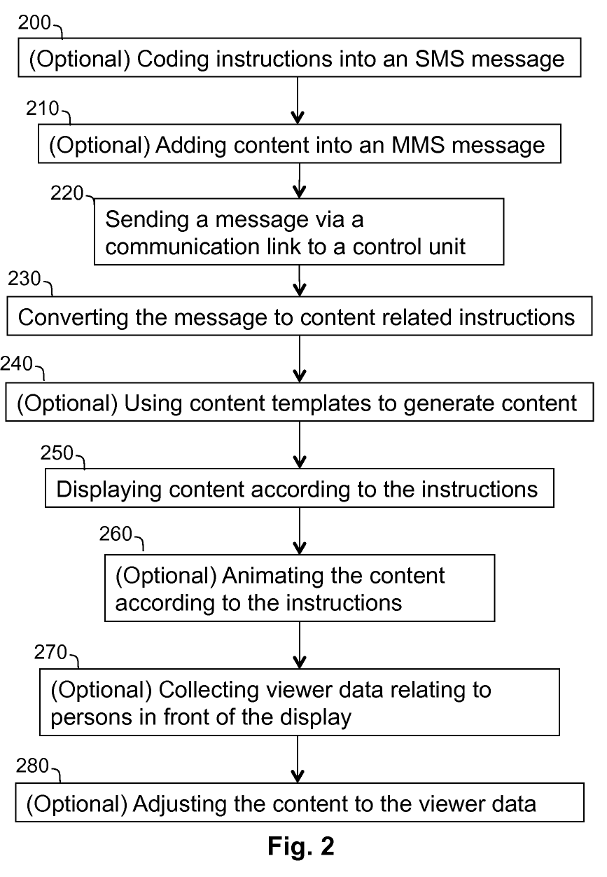

FIG. 2 is a high level flowchart illustrating a method of controlling a display connected to a control unit, according to some embodiments of the invention. The method comprises the following stages: sending a message via a communication link to the control unit (stage 220); converting the message to at least one instruction relating to at least one content item (stage 230); and displaying the at least one content item according to the at least one instruction (stage 250).

Messages may comprise encoded instructions such as relating to the timing (start, end, duration, cycles, etc.) for displaying the content items (stage 250), display sizes of various content items, movements of content items (for example headers or objects), animation, colors and color changes in content items, audio characteristics of the content items and so forth. The content items themselves may be parts of advertisements or commercials, comprise data that may be selected as relevant for people in front of the display, comprise content from various sources, including personally adapted content.

According to some embodiments of the invention, content items may be associated with either the control unit, the message itself, or a combination thereof. The message may comprise an SMS message and the method may further comprise allowing a user to code the at least one instruction into the SMS message (stage 200). The message may comprise an MMS message and the method may further comprise allowing a user to add at least one content item into the MMS message (stage 210).

According to some embodiments of the invention, the method may further comprise using content templates to generate content in relation to the at least one instruction (stage 240). Converting the message to instructions (stage 230) may relate to the content templates, comprising for example animation patterns, color schemes, and audio settings.

According to some embodiments of the invention, the method may further comprise animating at least one content item according to the at least one instruction (stage 260).

According to some embodiments of the invention, the method may further comprise collecting viewer data relating to persons in front of the display (stage 270). Viewer data may comprise measuring how long people stay before the advertisement, number of people observing display, operation control of display itself, estimating a number of approaching people, estimating the speed of passing persons and so on. Viewer data may be related to when determining the instructions and when displaying the content items (stage 250). According to some embodiments of the invention, the method may further comprise adjusting the at least one content item to the viewer data (stage 280).

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A data processing system for controlling a display comprising:
a control unit connected to the display and comprising a communication unit and a converter; and
a communication device connected via a communication link to the control unit,
wherein the communication device is arranged to send at least one message via the communication link to the communication unit of the control unit,
wherein the converter is arranged to convert the message to at least one instruction relating to at least one content item, and
wherein the display is arranged to display the at least one content item according to the at least one instruction from the control unit.

2. The data processing system of claim 1, wherein the control unit further comprises a content database comprising content, and wherein at least part of the instructions relates to the content.

3. The data processing system of claim 1, wherein the control unit further comprises a database comprising at least one content template, and wherein the converter is arranged to convert the message to at least one instruction relating to at least one content item in relation to the at least one content template.

4. The data processing system of claim 1, further comprising a camera connected via the communication link to the communication device and arranged to collect viewer data relating to persons in front of the display.

5. The data processing system of claim 1, wherein the at least one message comprises the at least one content item.

6. The data processing system of claim 1, wherein the at least one instruction comprises animation instructions relating to the at least one content item.

7. The data processing system of claim 1, wherein the communication unit comprises a SIM card.

8. The data processing system of claim 1, wherein the at least one instruction comprises at least one of: timing of displaying at least one content item, display sizes of various content items, movements of the at least one content item, animation, colors and color changes in the at least one content item, audio characteristics of the at least one content item.

9. An advertising system comprising:
a plurality of displays and a plurality of control units, such that each of the displays is connected to a control unit comprising a communication unit and a converter;
at least one communication device connected via at least one communication link to at least some of the control units; and
a managing unit connected via at least one communication link to the plurality of control units and to the at least one communication device,
wherein the at least one communication device is arranged to send a plurality of messages via the at least one communication link to the communication units of the plurality of control units, such that each message is sent to at least one target control unit,
wherein in each control unit, the converter is arranged to convert each message sent to the control unit to at least one instruction relating to at least one content item,
wherein the plurality of displays are arranged to display content items according to the at least one instruction from the connected control unit,
and wherein the managing unit is arranged to coordinate the plurality of displays in respect to the plurality of messages.

10. The advertising system of claim 9, wherein the at least one instruction comprises at least one of: timing of displaying at least one content item, display sizes of various content items, movements of the at least one content item, animation, colors and color changes in the at least one content item, audio characteristics of the at least one content item.

11. The advertising system of claim 9, further comprising at least one camera connected via the communication link to at least one communication device and arranged to collect viewer data relating to persons in front of the display, wherein the managing unit is arranged to coordinate the plurality of displays in respect to the plurality of messages and in respect to the viewer data.

12. The advertising system of claim 9, further comprising external information sources, wherein the managing unit is arranged to coordinate the plurality of displays in respect to the plurality of messages and in respect to data from the external information sources.

13. A method of controlling a display connected to a control unit, the method comprising:
sending a message via a communication link to the control unit;
converting the message to at least one instruction relating to at least one content item; and
displaying the at least one content item according to the at least one instruction.

14. The method of claim 13, wherein the at least one content item is associated with the control unit.

15. The method of claim 13, wherein the at least one content item is associated with the message.

16. The method of claim 13, wherein the message is an SMS message and further comprising allowing a user to code the at least one instruction into the SMS message.

17. The method of claim 13, wherein the message is an MMS message and further comprising allowing a user to add at least one content item into the MMS message.

18. The method of claim 13, further comprising using content templates to generate content in relation to the at least one instruction.

19. The method of claim 13, further comprising animating the at least one content item according to the at least one instruction.

20. The method of claim 13, further comprising collecting viewer data relating to persons in front of the display and adjusting the at least one content item to the viewer data.
